(19) United States
(12) Patent Application Publication
(10) Pub. No.: US 2026/0064346 A1
(43) Pub. Date: Mar. 5, 2026

(54) DISPLAY SYSTEM

(71) Applicant: SEIKO EPSON CORPORATION, Tokyo (JP)

(72) Inventor: Takehiko TONE, MATSUMOTO-SHI (JP)

(21) Appl. No.: 19/313,430

(22) Filed: Aug. 28, 2025

(30) Foreign Application Priority Data
Aug. 29, 2024 (JP) 2024-147336

(51) Int. Cl. G06F 3/14; G09G 3/00; G09G 5/00

(52) U.S. Cl. CPC G06F 3/1415; G09G 3/002; G09G 5/006; G09G 2360/08; G09G 2370/12; G09G 2370/20

(57) ABSTRACT

According to an aspect, there is provided a display system including an image processing device and a display device. The image processing device includes a first acquirer configured to acquire first image data from a first application program and a second acquirer configured to acquire second image data from a second application program, the display device includes a first communicator to which the image processing device is connected by wire, a second communicator connected to a first information processing device by wire or radio, a receiver configured to receive a first request to display a plurality of images side by side in a display region, and an image display configured to display an image in the display region. When displaying the first image data and the second image data side by side in the display region, the image display displays, in the display region, an image of third image data generated based on the first image data and the second image data and transferred from the image processing device.

The present application is based on, and claims priority from JP Application Serial Number 2024-147336, filed August 29, 2024, the disclosure of which is hereby incorporated by reference herein in its entirety.

### BACKGROUND

### 1. Technical Field

The present disclosure relates to a display system.

### 2. Related Art

The electronic blackboard system described in JP-A-2023-147131 includes a projector, a streaming device connected to the projector by an HDMI (registered trademark; the same applies below), a terminal machine connected to the streaming device by Wi-Fi (registered trademark), and a board functioning as a screen. The streaming device has a cast function and a mirroring function (see JP-A-2023-147131).

Note that HDMI is an abbreviation of High Definition Multimedia Interface.

Here, the cast function is a function of transferring a moving image viewed on a smartphone, a tablet, a personal computer, or the like to a streaming device and enabling the moving image to be viewed on a large-screen television.

The mirroring function is a function of directly projecting a content screen of a smartphone, a tablet, or the like onto a board via a projector.

JP-A-2023-147131 is an example of the related art.

However, in the related art, when it is assumed that image data supplied from a plurality of input sources is divided and displayed on a projection screen of the projector, even if the streaming device has a plurality of cast functions, the image data input for each of the cast functions cannot be divided and displayed on the projection screen of the projector.

That is, since the projector recognizes the streaming device as one input source, for example, it is possible to divide and display image data input from the streaming device and image data input from a personal computer via another HDMI cable on the projection screen of the projector. However, it is not possible to divide and display the image data input for each of cast functions of the streaming device on the projection screen of the projector.

### SUMMARY

According to an aspect of the present disclosure, there is provided a display system including: an image processing device; and a display device, wherein the image processing device includes: a first acquirer configured to acquire first image data from a first application program; and a second acquirer configured to acquire second image data from a second application program, the display device includes: a first communicator to which the image processing device is connected by wire; a second communicator connected to a first information processing device by wire or radio; a receiver configured to receive a first request to display a plurality of images side by side in a display region; and an image display configured to display an image in the display region, when displaying the first image data and the second image data side by side in the display region, the image display displays, in the display region, an image of third image data generated based on the first image data and the second image data and transferred from the image processing device, and, when displaying the first image data and fourth image data acquired from the first information processing device side by side in the display region, the image display displays, in the display region, an image of fifth image data generated based on the first image data transferred from the image processing device and the fourth image data transferred from the first information processing device.

### BRIEF DESCRIPTION OF THE DRAWINGS

FIG. 1 is a diagram illustrating a configuration example of a display system according to an embodiment.

FIG. 2 is a diagram illustrating a configuration example of an image processing device according to the embodiment.

FIG. 3 is a diagram illustrating a configuration example of a display device according to the embodiment.

FIG. 4 is a diagram illustrating a specific example of the image processing device, the display device, and a first information processing device according to the embodiment.

FIG. 5 is a diagram illustrating an example of a first setting screen according to the embodiment.

FIG. 6 is a diagram illustrating an example of a second setting screen according to the embodiment.

FIG. 7 is a diagram illustrating an example of a 2a-th setting screen according to the embodiment.

FIG. 8 is a diagram illustrating an example of a two-screen display image according to the embodiment.

FIG. 9 is a diagram illustrating another example of the two-screen display image according to the embodiment.

FIG. 10 is a diagram illustrating an example of a processing sequence in the case in which an image of a first application program and an image of a second application program of a first communicator are displayed side by side according to the embodiment.

FIG. 11 is a diagram illustrating an example of a processing sequence in the case in which an image of the first application program of the first communicator and an image of a second communicator are displayed side by side according to the embodiment.

FIG. 12 is a diagram illustrating an example of a processing sequence in the case in which an image of the first application program and an image of the second application program of the first communicator are displayed side by side and at the time when there is no signal of the first application program according to the embodiment.

FIG. 13 is a diagram illustrating an example of a processing sequence in the case in which an image of the first application program of the first communicator and an image of the second communicator are displayed side by side and at the time when there is no signal of the first application program according to the embodiment.

FIG. 14 is a diagram illustrating a configuration example of an a-th display system in which the first application program is stored in an a-th image processing device according to the embodiment.

FIG. 15 is a diagram illustrating an example of a processing sequence in the case in which an image of the first application program and an image of the second application program of the first communicator are displayed side by side in the a-th display system according to the embodiment.

### DESCRIPTION OF EMBODIMENTS

An embodiment is explained below with reference to the drawings.

The embodiment is explained.

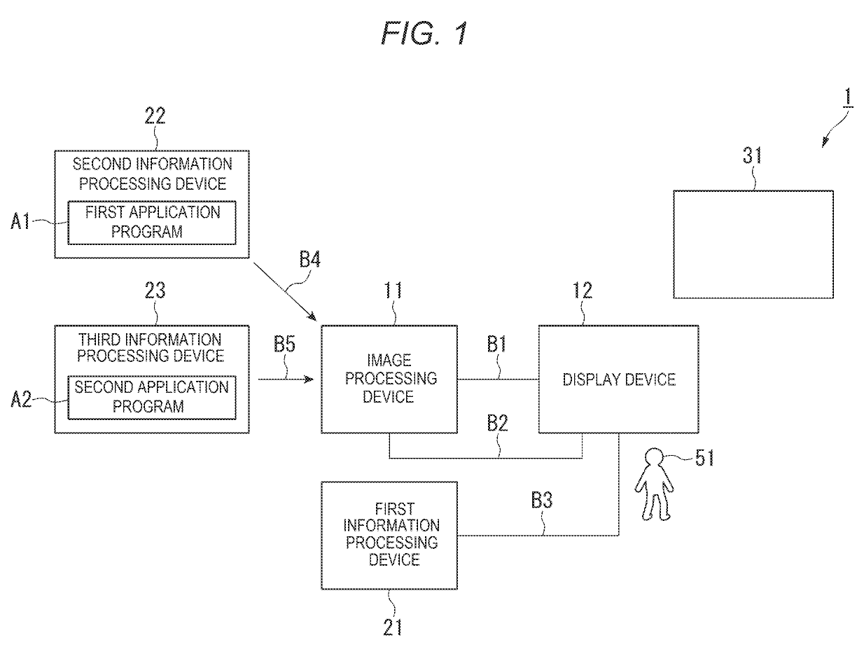

FIG. 1 is a diagram illustrating a schematic configuration example of a display system 1 according to the embodiment.

The display system 1 includes an image processing device 11 and a display device 12.

In the present embodiment, the display system 1 includes a first information processing device 21, a second information processing device 22, and a third information processing device 23.

In the present embodiment, the display system 1 includes a display region 31.

The second information processing device 22 stores a first application program A1.

The third information processing device 23 stores a second application program A2.

The display region 31 is a region where an image is displayed by the display device 12.

The image processing device 11 and the display device 12 are connected to each other via a first communication path B1 and are connected to each other via a second communication path B2.

Here, the first communication path B1 is a wired communication path.

The second communication path B2 is a wired or wireless communication path.

In the present embodiment, the display device 12 and the image processing device 11 are separate. However, as another example, the display device 12 and the image processing device 11 may be integrated.

The first information processing device 21 and the display device 12 are connected via a third communication path B3.

Here, the third communication path B3 is a wired or wireless communication path.

The second information processing device 22 and the image processing device 11 are connected via a fourth communication path B4.

Here, the fourth communication path B4 is a wired or wireless communication path.

The third information processing device 23 and the image processing device 11 are connected via a fifth communication path B5.

Here, the fifth communication path B5 is a wired or wireless communication path.

A user 51 is also illustrated in FIG. 1.

In the present embodiment, the user 51 views an image displayed in the display region 31.

In the present embodiment, the user 51 performs operation on the display device 12.

The operation may be performed based on, for example, a screen displayed in the display region 31.

The operation may be performed using, for example, a remote controller manually operated by the user 51 or may be performed using an operation unit provided in the display device 12.

In the example illustrated in FIG. 1, the display system 1 includes the image processing device 11, the display device 12, the first information processing device 21, the second information processing device 22, the third information processing device 23, the display region 31, and the communication paths.

As another example, the display system 1 may be grasped as including the image processing device 11, the display device 12, the first communication path B1, and the second communication path B2 but not including the other any one or more components.

For example, when the second communication path B2 or another communication path is a wireless communication path, the display system 1 may be grasped as not including the wireless communication path.

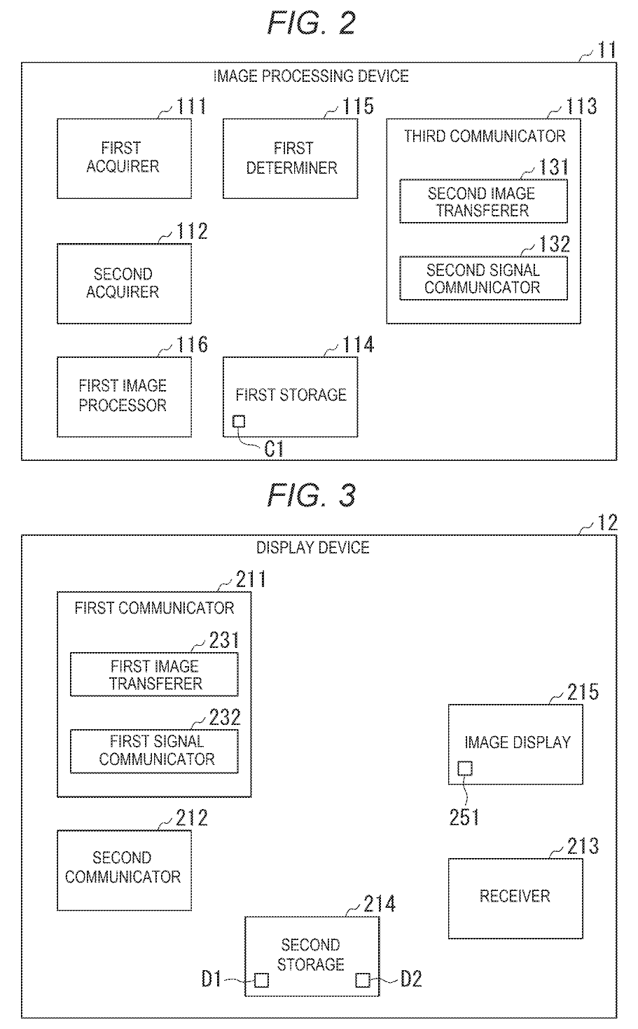

FIG. 2 is a diagram illustrating a configuration example of the image processing device 11 according to the embodiment.

The image processing device 11 includes a first acquirer 111, a second acquirer 112, a third communicator 113, a first storage 114, a first determiner 115, and a first image processor 116.

The third communicator 113 includes a second image transferer 131 and a second signal communicator 132.

The first storage 114 stores first predetermined image data C1.

The first acquirer 111 acquires first image data from the first application program A1.

Here, for example, the second information processing device 22 may be grasped as having a function of transmitting image data of the first application program A1 and the first acquirer 111 may be grasped as having a function of receiving the image data of the first application program A1.

The second acquirer 112 acquires second image data from the second application program A2.

Here, for example, the third information processing device 23 may be grasped as having a function of transmitting image data of the second application program A2 and the second acquirer 112 may be grasped as having a function of receiving the image data of the second application program A2.

Acquisition of image data of an application program such as the first application program A1 or the second application program A2 may be performed by, for example, mirroring of a display screen of a device such as the second information processing device 22 or the third information processing device 23 or may be performed by receiving image data stored in the device such as the second information processing device 22 or the third information processing device 23 from the device.

As a function of the mirroring, a function of any standard may be used. For example, AirPlay (registered trademark), Miracast (registered trademark), which is a general-purpose standard, DLNA (registered trademark), or WiDi may be used.

In the present embodiment, the third communicator 113 communicates with the display device 12.

The second image transferer 131 transfers image data to the display device 12.

The second signal communicator 132 communicates signals with the display device 12.

Here, the second signal communicator 132 may communicate a predetermined control signal. The control signal may include, for example, a control signal for notifying a display target image from the display device 12 to the image processing device 11 and a control signal for, when the display target image has not been acquired in the image processing device 11, notifying the display device 12 to that effect.

The first storage 114 stores various data.

The first predetermined image data C1 is, for example, data of a single color image. The single color may be, for example, black or may be another color.

The first determiner 115 performs predetermined determination. In the present embodiment, the first determiner 115 determines the presence or absence of a signal of an application program such as the first application program A1 or the second application program A2.

The first image processor 116 performs predetermined image processing. In the present embodiment, the first image processor 116 may generate, for example, one piece of image data in which two pieces of image data are arranged in parallel.

In the present embodiment, the first image processor 116 generates one piece of image data in which the image data of the first application program A1 and the image data of the second application program A2 are arranged in parallel.

In the present embodiment, when the image data of the first application program A1 or the second application program A2 has not been acquired, the first image processor 116 may use the first predetermined image data C1 instead of the image data.

FIG. 3 is a diagram illustrating a configuration example of the display device 12 according to the embodiment.

The display device 12 includes a first communicator 211, a second communicator 212, a receiver 213, a second storage 214, and an image display 215.

The first communicator 211 includes a first image transferer 231 and a first signal communicator 232.

The second storage 214 includes first OSD data D1 and second predetermined image data D2.

The image display 215 includes an OSD display 251.

The first communicator 211 may be called, for example, first input unit and the second communicator 212 may be called, for example, second input unit.

In the present embodiment, the first communicator 211 communicates with the image processing device 11.

The first image transferer 231 receives image data transferred from the image processing device 11. In the present embodiment, this transfer is performed via the first communication path B1.

The first signal communicator 232 communicates signals with the image processing device 11. In the present embodiment, this communication is performed via the second communication path B2.

Here, in the present embodiment, image transfer is performed between the first image transferer 231 of the display device 12 and the second image transferer 131 of the image processing device 11 and signal communication is performed between the first signal communicator 232 of the display device 12 and the second signal communicator 132 of the image processing device 11.

In the present embodiment, the second communicator 212 communicates with the first information processing device 21. In the present embodiment, this communication is performed via the third communication path B3.

In the present embodiment, acquiring image data from the first information processing device 21 with the second communicator 212 is performed by, for example, mirroring of a display screen of the first information processing device 21.

The receiver 213 receives a predetermined request. In the present embodiment, the receiver 213 receives a first request. The first request is a request to display a plurality of images side by side in the display region 31.

The second storage 214 stores various data.

The first OSD data D1 is predetermined OSD data. In the present embodiment, the first OSD data D1 includes, for example, data of a predetermined setting screen and data of "No Signal".

The second predetermined image data D2 is, for example, data of a single color image. The single color may be, for example, black or may be another color.

The image display 215 displays an image in the display region 31.

Here, the image display 215 may perform predetermined image processing. In the present embodiment, the image display 215 may generate, for example, one piece of image data in which two pieces of image data are arranged in parallel.

In the present embodiment, the image display 215 generates one piece of image data in which image data from the image processing device 11 and image data from the first information processing device 21 are arranged in parallel and displays the image data in the display region 31.

In the present embodiment, when two pieces of image data are already arranged in parallel and included in the image data from the image processing device 11, the image display 215 displays the image data from the image processing device 11 in the display region 31.

In the present embodiment, when image data from the image processing device 11 or image data from the first information processing device 21 has not been acquired, the image display 215 may use the second predetermined image data D2 instead of the image data.

The OSD display 251 performs, based on the first OSD data D1, control to display a predetermined OSD image in the display region 31.

In the present embodiment, for convenience of explanation, functions of the OSD display 251 provided in the image display 215 are distinguished and explained. However, for example, the functions of the OSD display 251 may be included in functions of the image display 215 and may not be clearly distinguished.

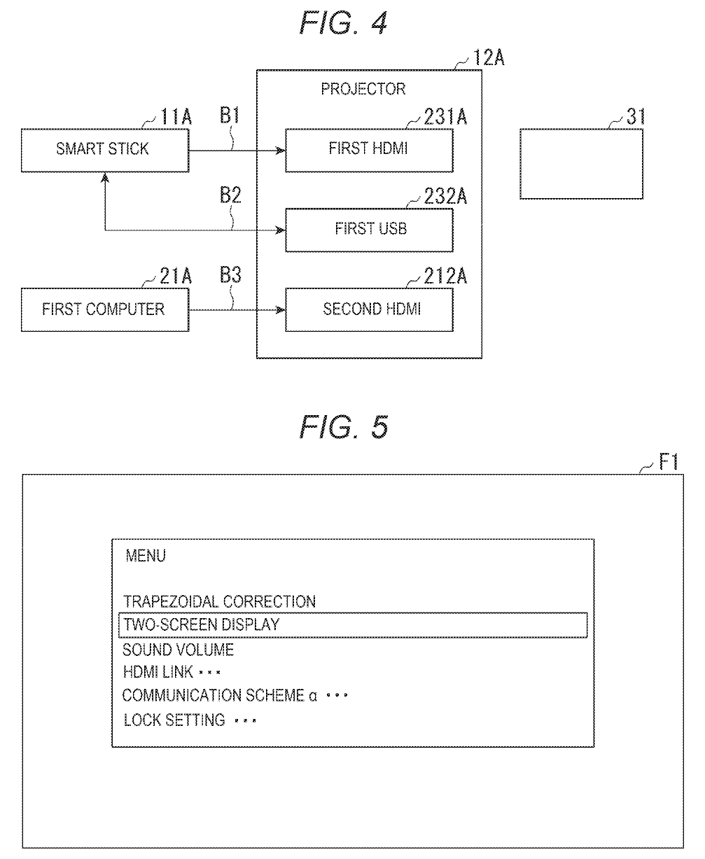

FIG. 4 is a diagram illustrating a specific example of the image processing device 11, the display device 12, and the first information processing device 21 according to the embodiment.

In this example, the image processing device 11 is configured from a smart stick 11A including an operating system (OS).

The display device 12 is configured from a projector 12A.

The first information processing device 21 is configured from a first computer 21A.

Although not illustrated, the second information processing device 22 is configured from a second computer and the third information processing device 23 is configured from a third computer.

The first image transferer 231 of the display device 12 is configured from a first HDMI 231A, which is an HDMI.

The first signal communicator 232 of the display device 12 is configured from a first USB 232A, which is a USB (registered trademark; the same applies below). USB is an abbreviation of Universal Serial Bus.

The second communicator 212 of the display device 12 has a function of an image transferer and is configured from a second HDMI 212A, which is an HDMI.

In this example, the display region 31 is a region of a screen onto which an image of display target image data is projected by the projector 12A.

As another example, the display region 31 may be a display region of a display screen that displays an image of display target image data output from the projector 12A.

Here, for example, a configuration in which the first HDMI 231A and the first USB 232A of the projector 12A and the smart stick 11A are always connected may be used.

In the present embodiment, the projector 12A and the smart stick 11A are separate. However, as another example, the projector 12A and the smart stick 11A may be integrated. As a specific example, the smart stick 11A may be provided on the inside of the projector 12A.

FIG. 5 is a diagram illustrating an example of a first setting screen F1 according to the embodiment.

In the present embodiment, the first setting screen F1 is displayed in the display region 31 by the OSD display 251 of the display device 12. The user 51 is capable of performing various settings by performing predetermined operation while viewing the first setting screen F1. In the display device 12, the OSD display 251 receives content of setting based on operation performed by the user 51.

The first setting screen F1 may be called, for example, menu screen.

In the example illustrated in FIG. 5, items of "trapezoidal correction", "two-screen display", "sound volume", "HDMI link...", "communication scheme α...", and "lock setting..." are displayed as a menu on the first setting screen F1.

Here, the communication scheme α may be, for example, Bluetooth (registered trademark).

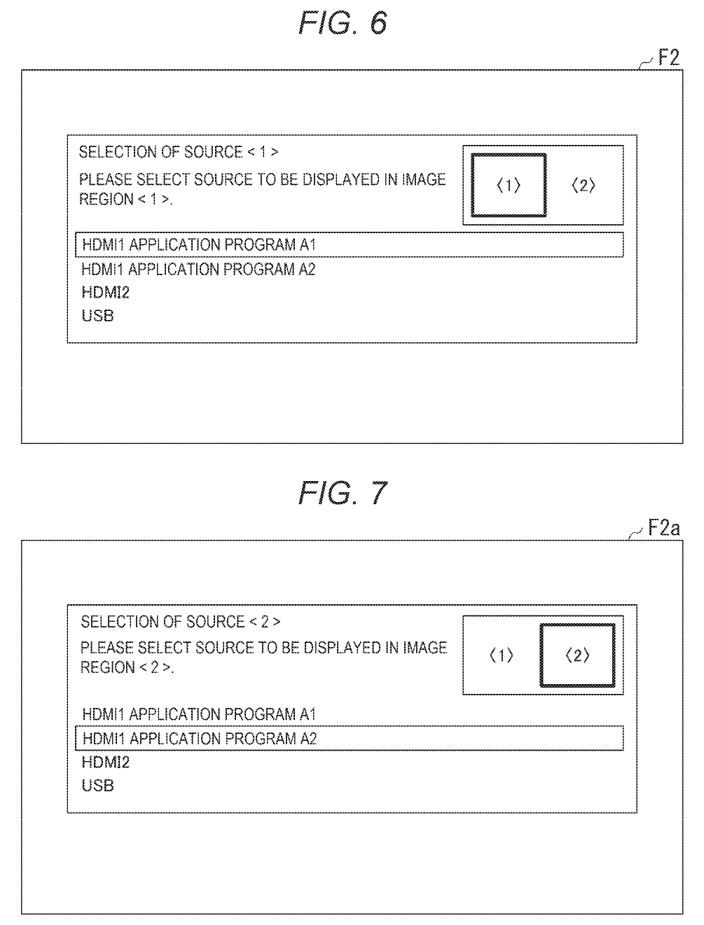

FIG. 6 is a diagram illustrating an example of a second setting screen F2 according to the embodiment.

In the present embodiment, when setting of "two-screen display" is selected on the first setting screen F1 illustrated in FIG. 5, the second setting screen F2 is displayed.

In the present embodiment, the second setting screen F2 is displayed in the display region 31 by the OSD display 251 of the display device 12. The user 51 is capable of performing various settings by performing predetermined operation while viewing the second setting screen F2. In the display device 12, the OSD display 251 receives content of setting based on operation performed by the user 51.

The second setting screen F2 may be called, for example, source selection screen.

In the example illustrated in FIG. 6, on the second setting screen F2, as information concerning selection of a source <1>, a message "Please select a source to be displayed in an image region <1>", selectable items, and an image of virtual image regions of left and right two screens are displayed.

In the example illustrated in FIG. 6, items of "HDMI1 application program A1", "HDMI1 application program A2", "HDMI2", and "USB" are displayed as the selectable items.

In the image of the virtual image regions of the left and right two screens, the image region on the left side corresponds to <1> and the image region on the right side corresponds to <2>.

In the image of the virtual image regions of the left and right two screens, a thick frame indicating a scene in which the source <1> of the image region <1> on the left side is selected is displayed in the image region on the left side.

In the example illustrated in FIG. 6, "HDMI1" corresponds to the first HDMI 231A in the example illustrated in FIG. 4, "HDMI2" corresponds to the second HDMI 212A in the example illustrated in FIG. 4, and "USB" corresponds to the first USB 232A in the example illustrated in FIG. 4.

In the example illustrated in FIG. 6, the "application program A1" corresponds to the first application program A1 and the "application program A2" corresponds to the second application program A2.

FIG. 7 is a diagram illustrating an example of a 2a-th setting screen F2a according to the embodiment.

Here, the 2a-th setting screen F2a is an example of a screen in the case in which a setting target image region in the second setting screen F2 illustrated in FIG. 6 has changed.

That is, in the example illustrated in FIG. 7, concerning selection of the source <2>, a message "Please select a source to be displayed in the image region <2>" is displayed.

In the example illustrated in FIG. 7, in the image of the virtual image regions of the left and right two screens, a thick frame indicating a scene in which the source <2> of the image region <2> on the right side is selected is displayed in the image region on the right side.

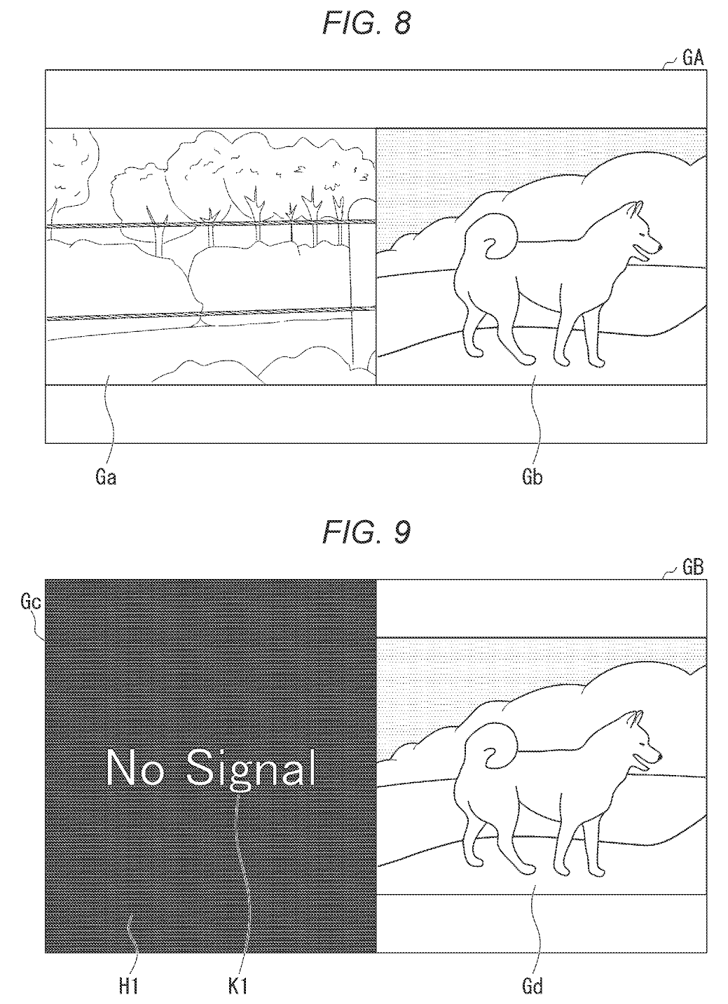

FIG. 8 is a diagram illustrating an example of a two-screen display image according to the embodiment.

In FIG. 8, an A-th image GA is illustrated as an example of the two-screen display image.

The A-th image GA is an image including left and right two images and is configured by arranging an a-th image Ga on the left side and a b-th image Gb on the right side.

In the present embodiment, for convenience of explanation, the A-th image GA is regarded as an image having two screens. However, for example, the A-th image GA may be grasped as an image of one screen in which these two screens are integrated.

As an example, the a-th image Ga may be an image of the first application program A1 and the b-th image Gb may be an image of the second application program A2. Note that these images may be set to be reversed left and right.

As another example, the a-th image Ga may be an image of the first application program A1 or the second application program A2 and the b-th image Gb may be an image received from the first information processing device 21. Note that these images may be set to be reversed left and right.

FIG. 9 is a diagram illustrating another example of the two-screen display image according to the embodiment.

In FIG. 9, a B-th image GB is illustrated as another example of the two-screen display image.

The B-th image GB is an image including left and right two images and is configured by arranging a c-th image Gc on the left side and a d-th image Gd on the right side.

In the c-th image Gc on the left side, first OSD information K1 is displayed near the center of a first predetermined color image H1 having a predetermined color.

The first OSD information K1 is character information "No Signal" indicating that a signal is not detected.

A signal not being detected may be called, for example, undetected.

As an example, the c-th image Gc may be an image in the case in which a signal of the first application program A1 is undetected and the d-th image Gd may be an image of the second application program A2. Note that these images may be set to be reversed left and right.

As another example, the c-th image Gc may be an image in the case in which a signal received from the first information processing device 21 is undetected and the d-th image Gd may be an image of the first application program A1 or the second application program A2. Note that these images may be set to be reversed left and right.

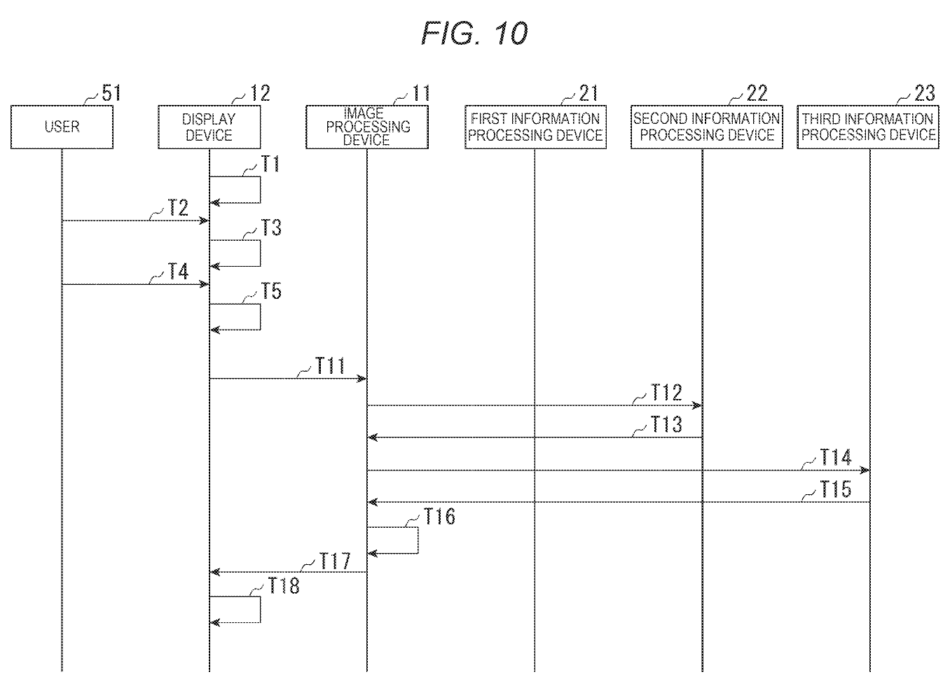

FIG. 10 is a diagram illustrating an example of a processing sequence in the case in which an image of the first application program A1 and an image of the second application program A2 of the first communicator 211 are displayed side by side according to the embodiment.

In processing T1, the display device 12 displays the first setting screen F1 illustrated in FIG. 5 in the display region 31.

In processing T2, the user 51 views the first setting screen F1 and instructs two-screen display.

In processing T3, the display device 12 displays the second setting screen F2 illustrated in FIG. 6 in the display region 31 and displays the 2a-th setting screen F2a illustrated in FIG. 7 in the display region 31, for example, when setting on the screen is completed.

In processing T4, the user 51 views the second setting screen F2 and the 2a-th setting screen F2a and instructs selection of a source.

In processing T5, the display device 12 stores source setting information including selection content of a source of each of the two screens.

In this example, displaying the image of the first application program A1 and the image of the second application program A2 side by side is set.

In processing T11, with the first signal communicator 232, the display device 12 instructs the image processing device 11 to perform the two-screen display and instructs the image processing device 11 of the source <1> and the source <2>, which are the selected sources.

Here, in this example, for convenience of explanation, the two selected sources are referred to as source <1> and source <2>.

In processing T12, the image processing device 11 transmits a signal detection request for the selected source <1> to the second information processing device 22.

In processing T13, the second information processing device 22 transmits a signal detection response for the selected source <1> and image data <1> corresponding to the source <1> to the image processing device 11. The image processing device 11 acquires the signal detection response and the image data.

In processing T14, the image processing device 11 transmits a signal detection request for the selected source <2> to the third information processing device 23.

In processing T15, the third information processing device 23 transmits a signal detection response for the selected source <2> and image data <2> corresponding to the source <2> to the image processing device 11. The image processing device 11 acquires the signal detection response and the image data.

In processing T16, the image processing device 11 generates image data <3> from the acquired image data <1> and image data <2>.

In processing T17, the image processing device 11 transfers the image data <3> to the display device 12 with the second image transferer 131.

In processing T18, the display device 12 displays the image data <3> in the display region 31.

Here, display content of the image data <3> is, for example, the display content of the two-screen display illustrated in FIG. 8.

In the example illustrated in FIG. 10, the processing for acquiring the image data <2> of the source <2> is performed after the processing for acquiring the image data <1> of the source <1> is performed. However, another example, the order of these kinds of processing may be reversed.

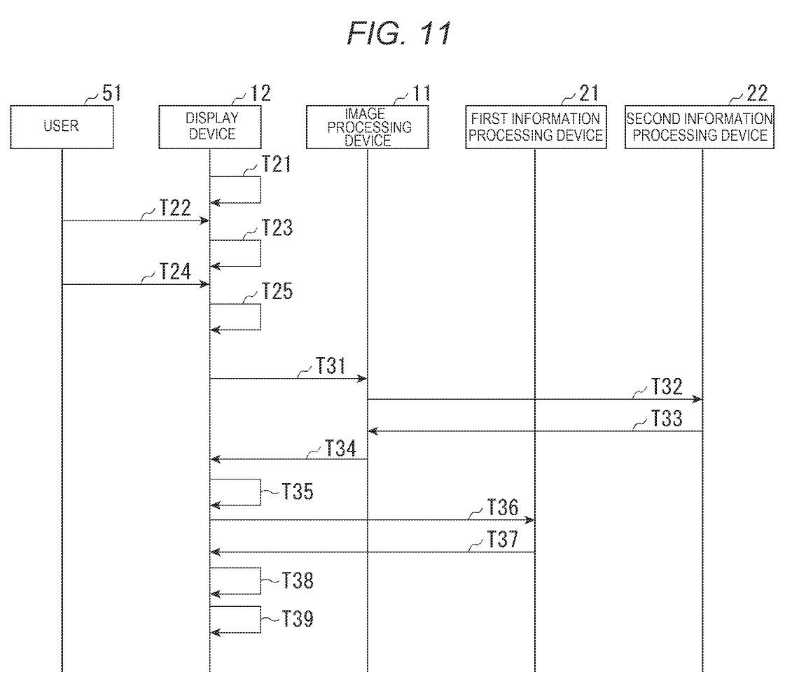

FIG. 11 is a diagram illustrating an example of a processing sequence in the case in which an image of the first application program A1 of the first communicator 211 and an image of the second communicator 212 are displayed side by side according to the embodiment.

Each of processing T21 to processing T25 is the same as each of the processing T1 to the processing T5 illustrated in FIG. 10.

In this example, displaying the image of the first application program A1 and the image of the second communicator 212 side by side is set.

In processing T31, the display device 12 instructs the image processing device 11 of the selected source <1> with the first signal communicator 232.

Here, in this example, for convenience of explanation, the two selected sources are referred to as source <1> and source <2>.

In processing T32, the image processing device 11 transmits a signal detection request for the selected source <1> to the second information processing device 22.

In processing T33, the second information processing device 22 transmits a signal detection response for the selected source <1> and the image data <1> corresponding to the source <1> to the image processing device 11. The image processing device 11 acquires the signal detection response and the image data.

In processing T34, the image processing device 11 transfers the image data <1> to the display device 12 with the second image transferer 131.

In processing T35, the display device 12 detects the selected source <2>. As a result, the display device 12 detects that the source <2> is provided from the first information processing device 21.

In processing T36, the display device 12 instructs the first information processing device 21 of the selected source <2> with the second communicator 212.

In processing T37, the first information processing device 21 transmits image data <4> corresponding to the selected source <2> to the display device 12. The display device 12 acquires the image data.

In processing T38, the display device 12 generates image data <5> from the acquired image data <1> and image data <4>.

In processing T39, the display device 12 displays the image data <5> in the display region 31.

Here, display content of the image data <5> is, for example, display content of two-screen display illustrated in FIG. 8.

In the example illustrated in FIG. 11, the processing for acquiring the image data <4> of the source <2> is performed after the processing for acquiring the image data <1> of the source <1> is performed. However, as another example, the order of these kinds of processing may be opposite.

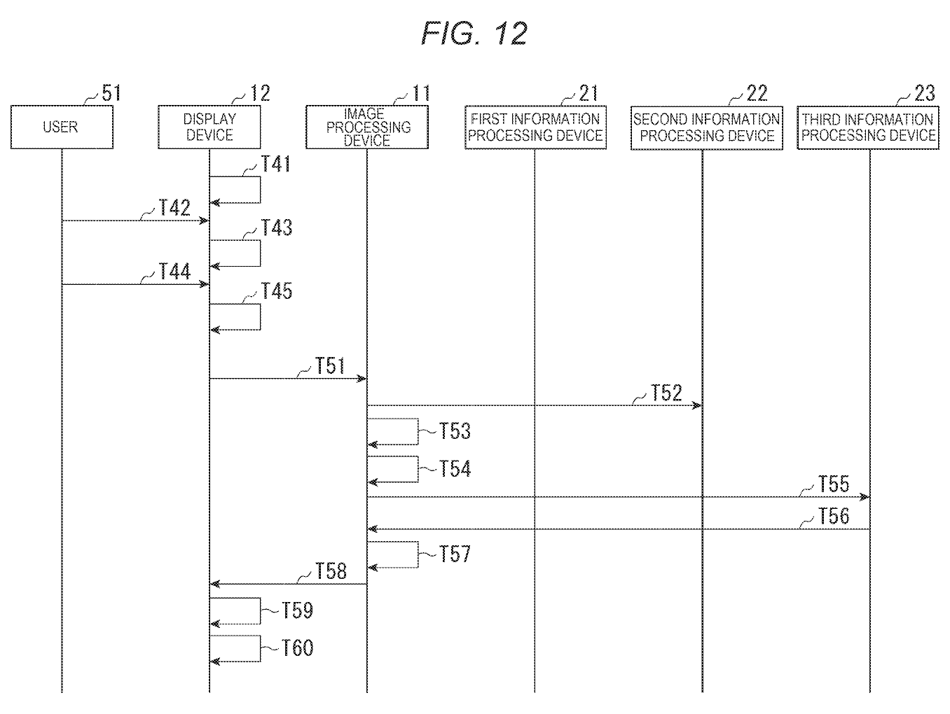

FIG. 12 is a diagram illustrating an example of a processing sequence at the time when an image of the first application program A1 and an image of the second application program A2 of the first communicator 211 are displayed side by side and at the time when there is no signal of the first application program A1 according to the embodiment.

Each of processing T41 to processing T45 is the same as each of the processing T1 to the processing T5 illustrated in FIG. 10.

In this example, displaying the image of the first application program A1 and the image of the second application program A2 side by side is set.

In processing T51, with the first signal communicator 232, the display device 12 instructs the image processing device 11 to perform two-screen display and instructs the image processing device 11 of the source <1> and the source <2>, which are the selected sources.

Here, in this example, for convenience of explanation, the two selected sources are referred to as source <1> and source <2>.

In processing T52, the image processing device 11 transmits a signal detection request for the selected source <1> to the second information processing device 22.

In processing T53, when a signal detection response for the source <1> does not come from the second information processing device 22 within a predetermined period, the image processing device 11 detects the signal detection response.

In processing T54, the image processing device 11 generates image data of a black image as image data <1> corresponding to the source <1>.

Here, in the present embodiment, the image processing device 11 generates the image data of the black image using the first predetermined image data C1.

The first predetermined image data C1 may be, for example, the image data of the black image.

In processing T55, the image processing device 11 transmits a signal detection request for the selected source <2> to the third information processing device 23.

In processing T56, the third information processing device 23 transmits a signal detection response for the selected source <2> and image data <2> corresponding to the source <2> to the image processing device 11. The image processing device 11 acquires the signal detection response and the image data.

In processing T57, the image processing device 11 generates image data <3> from the image data of the black image generated as the image data <1> and the acquired image data <2>.

In processing T58, the image processing device 11 transfers the image data <3> to the display device 12 with the second image transferer 131. The image processing device 11 transmits a signal including signal non-detection information to the display device 12 with the second signal communicator 132.

The signal non-detection information is information indicating that a signal of the source <1> is undetected.

In processing T59, the display device 12 generates image data <6> based on the first OSD data D1 and the image data <3>.

In processing T60, the display device 12 displays the generated image data <6> in the display region 31.

Here, display content of the image data <6> is, for example, the display content of the two-screen display illustrated in FIG. 9 and the black image and the predetermined OSD data are displayed on one screen.

In the example illustrated in FIG. 12, the processing for acquiring the image data <2> of the source <2> is performed after the processing for acquiring the image data <1> of the source <1> is performed. However, as another example, the order of these kinds of processing may be opposite.

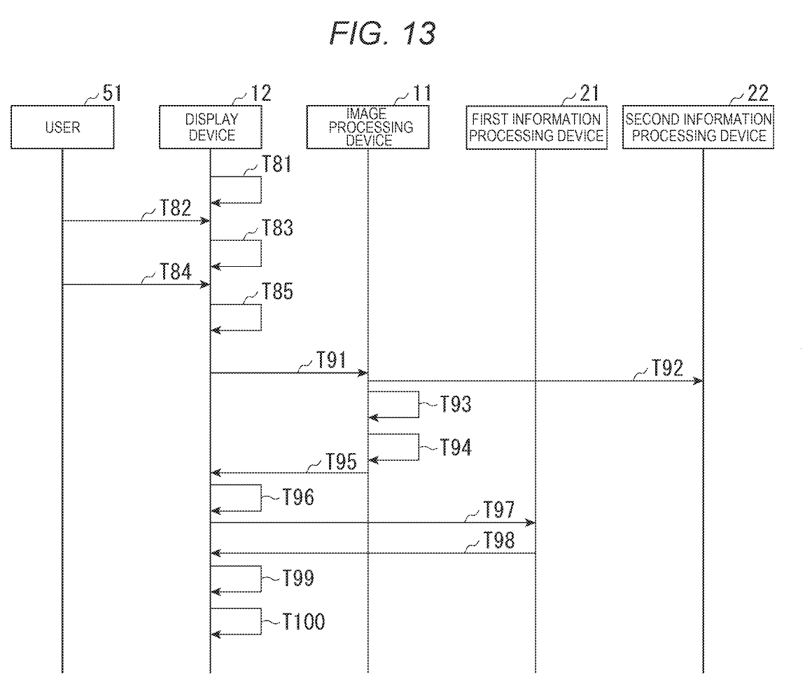

FIG. 13 is a diagram illustrating an example of a processing sequence in the case in which an image of the first application program A1 of the first communicator 211 and an image of the second communicator 212 are displayed side by side and at the time when there is no signal of the first application program A1 according to the embodiment.

Each of processing T81 to processing T85 is the same as each of the processing T1 to the processing T5 illustrated in FIG. 10.

In this example, displaying the image of the first application program A1 and the image of the second communicator 212 side by side is set.

In processing T91, the display device 12 instructs the image processing device 11 of the selected source <1> with the first signal communicator 232.

Here, in this example, for convenience of explanation, the two selected sources are referred to as source <1> and source <2>.

In processing T92, the image processing device 11 transmits a signal detection request for the selected source <1> to the second information processing device 22.

In processing T93, when a signal detection response for the source <1> does not come from the second information processing device 22 within a predetermined period, the image processing device 11 detects the signal detection response.

In processing T94, the image processing device 11 generates image data of a black image as the image data <1> corresponding to the source <1>.

Here, in the present embodiment, the image processing device 11 generates the image data of the black image using the first predetermined image data C1.

The first predetermined image data C1 may be, for example, the image data of the black image.

In processing T95, the image processing device 11 transfers the image data <1> to the display device 12 with the second image transferer 131.

In processing T96, the display device 12 detects the selected source <2>. As a result, the display device 12 detects that the source <2> is provided from the first information processing device 21.

In processing T97, the display device 12 instructs the first information processing device 21 of the selected source <2> with the second communicator 212.

In processing T98, the first information processing device 21 transmits image data <4> corresponding to the selected source <2> to the display device 12. The display device 12 acquires the image data.

In processing T99, the display device 12 generates image data <7> based on the first OSD data D1, the image data <1>, and the image data <4>.

In processing T100, the display device 12 displays the generated image data <7> in the display region 31.

Here, display content of the image data <7> is, for example, the display content of the two-screen display as illustrated in FIG. 9. A black image and predetermined OSD data are displayed on one screen.

In the example illustrated in FIG. 13, the processing for acquiring the image data <4> of the source <2> is performed after the processing for acquiring the image data <1> of the source <1> is performed. However, as another example, the order of these kinds of processing may be opposite.

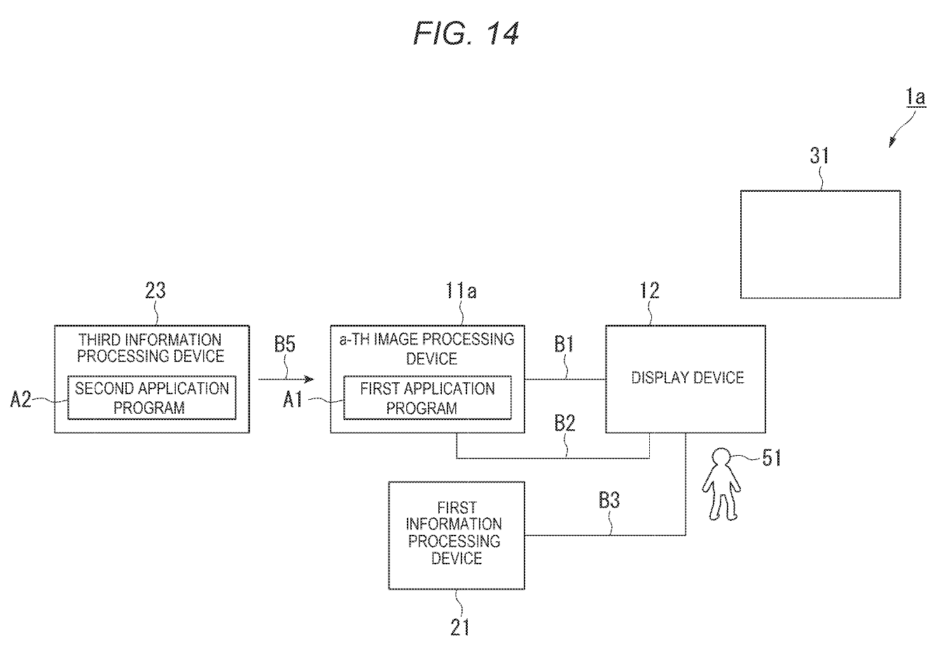

FIG. 14 is a diagram illustrating a configuration example of an a-th display system 1a in which the first application program A1 according to the embodiment is stored in the a-th image processing device 11a.

Here, the a-th display system 1a illustrated in FIG. 14 is different compared with the display system 1 illustrated in FIG. 1 in that the first application program A1 is stored in the a-th image processing device 11a instead of the second information processing device 22 illustrated in FIG. 1 and is the same in other points.

The a-th image processing device 11a may be an aspect of the image processing device 11 illustrated in FIG. 1. For example, the image processing device 11 illustrated in FIG. 1 in which the first application program A1 is installed may be grasped as the a-th image processing device 11a.

In the example illustrated in FIG. 14, the same components as those in the example illustrated in FIG. 1 are denoted by the same reference numerals and signs.

In the present embodiment, the a-th image processing device 11a starts the first application program A1 in a period in which an image of first image data corresponding to the first application program A1 is displayed in the display region 31.

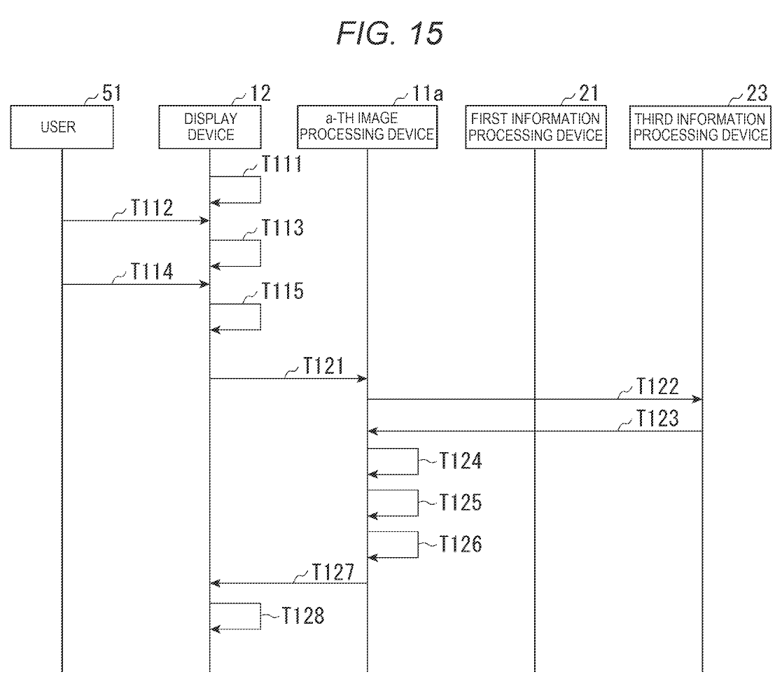

FIG. 15 is a diagram illustrating an example of a processing sequence in the case in which an image of the first application program A1 and an image of the second application program A2 of the first communicator 211 are displayed side by side in the a-th display system 1a according to the embodiment.

Each of processing T111 to processing T115 is the same as each of the processing T1 to the processing T5 illustrated in FIG. 10, respectively.

In this example, displaying the image of the first application program A1 and the image of the second application program A2 side by side is set.

In processing T121, with the first signal communicator 232, the display device 12 instructs the a-th image processing device 11a to perform the two-screen display and instructs the a-th image processing device 11a of the source <1> and the source <2>, which are the selected sources.

Here, in this example, for convenience of explanation, the two selected sources are referred to as source <1> and source <2>.

In processing T122, the a-th image processing device 11a transmits a signal detection request for the selected source <2> to the third information processing device 23.

In processing T123, the third information processing device 23 transmits a signal detection response for the selected source <2> and the image data <2> corresponding to the source <2> to the a-th image processing device 11a. The a-th image processing device 11a acquires the signal detection response and the image data.

In processing T124, the a-th image processing device 11a detects the selected source <1>. As a result, the a-th image processing device 11a detects that the source <1> is provided from the first application program A1.

In processing T125, the a-th image processing device 11a acquires the image data <1> corresponding to the source <1>.

In processing T126, the a-th image processing device 11a generates image data <3> from the acquired image data <1> and image data <2>.

In processing T127, the a-th image processing device 11a transfers the image data <3> to the display device 12 with the second image transferer 131.

In processing T128, the display device 12 displays the image data <3> in the display region 31.

Here, display content of the image data <3> is, for example, the display content of the two-screen display illustrated in FIG. 8.

In the example illustrated in FIG. 15, the processing for acquiring the image data <1> of the source <1> is performed after the processing for acquiring the image data <2> of the source <2> is performed. However, as another example, the order of these kinds of processing may be opposite.

As explained above, in the display system 1 according to the present embodiment, when the image processing device 11 can acquire image data of two application programs, that is, the first application program A1 and the second application program A2, the display device 12 can display images of the two image data side by side. The display device 12 can display an image of image data of one application program and an image received from the first information processing device 21 such as a computer side by side.

Here, a technique according to the present embodiment is explained by taking the configuration illustrated in FIG. 4 as an example.

Recently, a configuration in which a smart stick with an OS is combined with a projector as a peripheral device has been used.

An output video of the smart stick is treated as one of external inputs of the projector in the HDMI. The projector and the smart stick are connected by a USB as well for control.

Functions of the smart stick include a cast receiver function and, for example, casts of a plurality of standards are sometimes implemented as application programs.

Here, a function of displaying a plurality of external inputs on a multiscreen is provided as a function on the projector side. However, for example, when a cast application program on the inside of the smart stick is considered as a source, a multiscreen including the application program cannot be configured.

Thus, in the present embodiment, information for implementing, for a combination of images, each of a plurality of types of combination displays is exchanged between the smart stick and the projector through communication and display of a combination corresponding to the information is switched to be performed to enable, for example, multiscreen display of all combinations.

In the present embodiment, for example, in the projector, it is possible to divide and display an image of the first application program A1 and an image of the second application program A2 input via the smart stick. That is, the projector can divide and display images of image data of different application programs input from one source.

In the present embodiment, for example, in the projector, it is also possible to perform multiscreen display in which an external source and an application program of the OS of the smart stick are mixed.

Further, in the present embodiment, it is also possible to cause the OS of the smart stick and the projector to cooperate, for example, to cause the multiscreen display of the application program of the OS of the smart stick and the multiscreen function of the projector to cooperate.

In the present embodiment, a smart function is implemented by the smart stick while a basic projection function of the projector being used.

As explained above, in the present embodiment, for example, it is possible to implement the multiscreen function concerning the display by the projector, including implementing a cast function implemented on the smart stick side, while making operation by the user the same or substantially the same.

Here, on the smart stick side, for example, a function of the application program implemented in the smart stick may be used besides to the cast function.

As an example, when an interactive drawing application program is provided in the smart stick, it is possible to draw a picture or the like in two screens of an image of the drawing application program and an external input to the projector.

An example of a combination of images to be displayed is explained.

As an example, there is a combination of a cast with a signal and a cast with a signal. In this case, two images of the cast application program are displayed side by side on the OS side of the smart stick and the projector displays, on one screen, an image in which the two images are arranged side by side.

As another example, there is a combination of a cast with a signal and a cast without a signal. In this case, two images of the cast application program are displayed side by side on the OS side of the smart stick but a black screen is displayed for the case without a signal. The projector displays, on one screen, an image in which the two images are arranged side by side and displays information "No Signal" in an area of the black screen with an OSD.

As another example, there is a combination of an external input with a signal and a cast with a signal. In this case, an image of the cast application program is displayed on a full screen on the OS side of the smart stick and the projector displays two screens for the external input and the cast. Here, the external input is, for example, input from a computer other than the smart stick.

As another example, there is a combination of an external input with a signal and a cast without a signal. In this case, an image of the cast application program is displayed on a full screen on the OS side of the smart stick but a black screen is displayed because there is no signal. The projector displays two screens for the external input and the cast and displays information "No Signal" in an area of the black screen of the cast with an OSD. Here, the external input is, for example, input from a computer other than the smart stick.

A change in a signal state and a change in a combination of two screens are notified between the smart stick and the projector, and the display is switched to display corresponding to the changes to implement various combinations of images.

As an example, there is transition from a first state of a combination of a cast with a signal and a cast without a signal to a second state of a combination of a cast with a signal and a cast with a signal.

In this case, in the first state, two images of the cast application program are displayed side by side on the OS side of the smart stick but the black screen is displayed for the case without a signal. The projector displays, on one screen, an image in which the two images are arranged side by side and displays information "No Signal" in an area of the black screen with an OSD.

At this time, when being connected to the cast of "No Signal", the smart stick displays images of the application programs of both the casts as a presence signal. This is a change in a signal state from the first state to the second state.

The smart stick notifies the projector that the cast of "No Signal" changes to signal presence.

In response to receiving the notification, the projector releases the OSD of "No Signal".

As another example, in the case of a combination of an external input with a signal and a cast without a signal, the projector performs two-screen setting for selecting the external input and the cast. That is, the two-screen setting for the smart stick and the external input is performed by the two-screen function.

The projector instructs the smart stick to display one cast application program.

In response to this instruction, the smart stick displays an image of one cast application program on a full screen.

A configuration example according to the embodiment is explained.

The display system 1 according to the present embodiment includes the image processing device 11 and the display device 12.

The image processing device 11 includes the first acquirer 111 that acquires first image data from the first application program A1 and the second acquirer 112 that acquires second image data from the second application program A2.

The display device 12 includes the first communicator 211 to which the image processing device 11 is connected by wire, the second communicator 212 connected to the first information processing device 21 by wire or radio, the receiver 213 that receives a first request to display a plurality of images side by side in the display region 31, and the image display 215 that displays an image in the display region 31.

When the first image data and the second image data are displayed side by side in the display region 31, the image display 215 displays, in the display region 31, an image of third image data generated based on the first image data and the second image data and transferred from the image processing device 11.

When displaying the first image data and fourth image data acquired from the first information processing device 21 side by side in the display region 31, the image display 215 displays, in the display region 31, an image of fifth image data generated based on the first image data transferred from the image processing device 11 and the fourth image data transferred from the first information processing device 21.

Therefore, in the display system 1 according to the present embodiment, the input image data can be divided and displayed for each application program function.

Here, as an example, the image processing device 11, the display device 12, the display region 31, and the first information processing device 21 may be respectively a smart stick, a projector, a screen, and a computer. The computer may be, for example, a smartphone or a tablet.

The display system 1 according to the present embodiment has the following configuration.

The image processing device 11 stores the first predetermined image data C1.

When the image display 215 displays the first image data and the second image data side by side in the display region 31 and the first acquirer 111 has not detected a signal concerning the first application program A1, the image processing device 11 generates the third image data based on the first predetermined image data C1 and the second image data. The image display 215 displays, in the display region 31, an image of sixth image data generated based on the third image data and OSD data indicating that the signal concerning the first application program A1 is undetected.

Therefore, in the display system 1 according to the present embodiment, when a signal has not been successfully detected from one of the plurality of application programs, by additionally displaying the predetermined OSD data with the OSD function of the display device 12, for example, it is possible for the user 51 to grasp whether the display device 12 side is defective or a signal has not been successfully detected.

Here, the predetermined OSD data may be, for example, message information of "No Signal".

The first predetermined image data C1 may be, for example, data of a single color image of black or may be data of another image.

As an example, when the image processing device 11 acquires two pieces of cast image data, a signal of one piece of cast image data is not sometimes detected.

The display system 1 according to the present embodiment has the following configuration.

At least one of the image processing device 11 and the display device 12 stores the second predetermined image data D2.

When the image display 215 displays the first image data and the fourth image data side by side in the display region 31 and the first acquirer 111 has not detected a signal concerning the first application program A1, the image display 215 displays, in the display region 31, an image of seventh image data generated based on the second predetermined image data D2, the OSD data indicating that the signal concerning the first application program A1 is undetected, and the fourth image data.

Therefore, in the display system 1 according to the present embodiment, when a signal from an application program designated by the user 51 cannot be detected, by additionally displaying the predetermined OSD data with the OSD function of the display device 12, for example, it is possible for the user 51 to grasp whether the display device 12 side is defective or the signal cannot be detected.

Here, the predetermined OSD data may be, for example, message information of "No Signal".

The second predetermined image data D2 may be, for example, data of a single color image of black or may be data of another image.

As an example, when the image processing device 11 acquires one piece of cast image data, a signal of the cast image data is sometimes not detected.

The second predetermined image data D2 may be stored by, for example, the image processing device 11, may be stored by the display device 12, or may be stored by both of the image processing device 11 and the display device 12.

When the image processing device 11 stores the second predetermined image data D2, for example, the image processing device 11 transfers the second predetermined image data D2 to the display device 12. On the other hand, when the display device 12 stores the second predetermined image data D2, for example, the display device 12 uses the second predetermined image data D2 as the first image data.

In a configuration in which the image processing device 11 stores the first predetermined image data C1 and the second predetermined image data D2, for example, these pieces of data may be common data or may be separate data.

The display system 1 according to the present embodiment has the following configuration.

The first communicator 211 includes the first image transferer 231 that transfers image data between the image processing device 11 and the display device 12 and the first signal communicator 232 that communicates signals between the image processing device 11 and the display device 12.

Therefore, in the display system 1 according to the present embodiment, since the first communicator 211 includes the first signal communicator 232, for example, it is possible to communicate from the image processing device 11 to the display device 12 that a signal is undetected.

Here, the first image transferer 231 may include, for example, an HDMI.

The first signal communicator 232 may include, for example, a USB.

The a-th display system 1a according to the present embodiment has the following configuration.

The a-th image processing device 11a stores the first application program A1.

The a-th image processing device 11a starts the first application program A1 in a period in which the image of the first image data is displayed in the display region 31.

The a-th display system 1a and the a-th image processing device 11a may be one aspect of the display system 1 and the image processing device 11.

Therefore, in the display system 1 according to the present embodiment, when the first acquirer 111 is not selected as an input source, a processing load of the a-th image processing device 11a can be reduced by not starting the first application program A1.

In the a-th image processing device 11a, for example, the first application program A1 is started only when display of an image of the first application program A1 is requested from the display device 12.

The display system 1 according to the present embodiment has the following configuration.

The display system 1 includes the second information processing device 22.

The second information processing device 22 stores the first application program A1 and is connected to the image processing device 11 via the first acquirer 111.

A signal concerning the first application program A1 is a signal of first image data transferred from the second information processing device 22.

OSD data indicating that the signal concerning the first application program A1 is undetected is information indicating that the image data is unacquired.

Therefore, in the display system 1 according to the present embodiment, for example, the user 51 can determine, based on the screen of the display region 31, whether the second information processing device 22 and the image processing device 11 have not been successfully connected or whether an image has not been successfully transferred from the second information processing device 22 to the image processing device 11.

Here, as an example, the OSD data may be data for notifying that the second information processing device 22 and the image processing device 11 have been successfully connected but are not mirroring.

A program for implementing the function of any constituent unit in any device explained above may be recorded in a computer-readable recording medium and the program may be executed by causing a computer system to read the program. The "computer system" referred to here includes an operating system or hardware such as peripheral equipment. The "computer-readable recording medium" is a portable medium such as a flexible disc, a magneto-optical disc, a read only memory (ROM), or a compact disc (CD)-ROM or a storage device such as a hard disk incorporated in the computer system. The "computer-readable recording medium" includes a recording medium that retains a program for a certain period of time like a volatile memory on the inside of the computer system serving as a server or a client when the program is transmitted via a network such as the Internet or a communication line such as a telephone line. The volatile memory may be a RAM. The recording medium may be a non-transitory recording medium.

The program explained above may be transmitted from a computer system in which the program is stored in a storage device or the like to another computer system via a transmission medium or by a transmission wave in the transmission medium. The "transmission medium" for transmitting the program refers to a medium having a function of transmitting information like a network such as the Internet or a communication line such as a telephone line.

The program explained above may be a program for implementing some of the functions explained above. The program explained above may be a program that can implement the functions explained above in combination with a program already recorded on the computer system, a so-called differential file. The differential file may be called differential program.

The function of any constituent unit in any device explained above may be implemented by a processor. The kinds of processing in the embodiment may be implemented by a processor that operates based on information such as a program and a computer-readable recording medium that stores the information such as the program. In the processor, the functions of the units may be implemented by individual hardware or the functions of the units may be implemented by integrated hardware. The processor may include hardware and the hardware may include at least one of a circuit that processes a digital signal and a circuit that processes an analog signal. The processor may be configured using one or both of one or a plurality of circuit devices implemented on a circuit board and one or a plurality of circuit elements. An integrated circuit (IC) or the like may be used as the circuit device and a resistor, a capacitor, or the like may be used as the circuit element.

The processor may be a CPU. However, the processor is not limited to the CPU, and various processors such as a graphics processing unit (GPU) or a digital signal processor (DSP) may be used. The processor may be a hardware circuit by an application specific integrated circuit (ASIC). The processor may include a plurality of CPUs or may include a hardware circuit by a plurality of ASICs. The processor may include a combination of a plurality of CPUs and a hardware circuit by a plurality of ASICs. The processor may include one or more of an amplifier circuit, a filter circuit, and the like that process an analog signal.

While the embodiment is explained in detail above with reference to the drawings, a specific configuration is not limited to the embodiment and includes design and the like in a range not departing from the gist of the present disclosure.

### Summary of the present disclosure

A summary of the present disclosure is appended below.

### Appendix 1

A display system including:

an image processing device; and

a display device, wherein

the image processing device includes:

a first acquirer configured to acquire first image data from a first application program; and

a second acquirer configured to acquire second image data from a second application program,

the display device includes:

a first communicator to which the image processing device is connected by wire;

a second communicator connected to a first information processing device by wire or radio;

a receiver configured to receive a first request to display a plurality of images side by side in a display region; and

an image display configured to display an image in the display region,

when displaying the first image data and the second image data side by side in the display region, the image display displays, in the display region, an image of third image data generated based on the first image data and the second image data and transferred from the image processing device, and

when displaying the first image data and fourth image data acquired from the first information processing device side by side in the display region, the image display displays, in the display region, an image of fifth image data generated based on the first image data transferred from the image processing device and the fourth image data transferred from the first information processing device.

Accordingly, it is possible to divide and display input image data for each application program function.

### Appendix 2

The display system described in the Appendix 1, wherein

the image processing device stores first predetermined image data, and

when the image display displays the first image data and the second image data side by side in the display region and the first acquirer did not detect a signal concerning the first application program,

the image processing device generates the third image data based on the first predetermined image data and the second image data, and

the image display displays, in the display region, an image of sixth image data generated based on the third image data and OSD data indicating that the signal concerning the first application program is undetected.

Accordingly, when a signal has not been successfully detected from one of a plurality of application programs, by additionally displaying predetermined OSD data with an OSD function of the display device, for example, it is possible for a user to grasp whether the display device side is defective or a signal has not been successfully detected.

Appendix 3

The display system described in the Appendix 1 or the Appendix 2, wherein

at least one of the image processing device and the display device stores second predetermined image data, and

when the image display displays the first image data and the fourth image data side by side in the display region and the first acquirer did not detect a signal concerning the first application program,

the image display displays, in the display region, an image of seventh image data generated based on the second predetermined image data, OSD data indicating that the signal concerning the first application program is undetected, and the fourth image data.

Accordingly, when a signal from an application program designated by a user has not been successfully detected, by additionally displaying predetermined OSD data with an OSD function of the display device, it is possible for the user to grasp, for example, whether the display device side is defective or a signal has not been successfully detected.

Appendix 4

The display system described in any one of the Appendix 1 to the Appendix 3, wherein the first communicator includes:

an image transferer configured to transfer image data between the image processing device and the display device; and

a signal communicator configured to communicate a signal between the image processing device and the display device.

Accordingly, since the first communicator includes the signal communicator, for example, it is possible to communicate from the image processing device to the display device that a signal is undetected.

Appendix 5

The display system described in any one of the Appendix 1 to the Appendix 4, wherein

the image processing device stores the first application program, and

the image processing device starts the first application program in a period in which an image of the first image data is displayed in the display region.

Accordingly, when the first acquirer is not selected as an input source, by not starting the first application program, it is possible to reduce a processing load of the image processing device.

Appendix 6

The display system described in the Appendix 2 or the Appendix 3, further including a second information processing device, wherein

the second information processing device stores the first application program and is connected to the image processing device via the first acquirer,

the signal concerning the first application program is a signal of the first image data transferred from the second information processing device, and

the OSD data indicating that the signal concerning the first application program is undetected is information indicating that image data is unacquired.

Accordingly, for example, the user can determine, based on a screen of the display region, whether the second information processing device and the image processing device have not been successfully connected or whether an image has not been successfully transferred from the second information processing device to the image processing device.

What is claimed is:

1. A display system comprising:
an image processing device; and
a display device, wherein
the image processing device includes:
a first acquirer configured to acquire first image data from a first application program; and
a second acquirer configured to acquire second image data from a second application program,
the display device includes:
a first communicator to which the image processing device is connected by wire;
a second communicator connected to a first information processing device by wire or radio;
a receiver configured to receive a first request to display a plurality of images side by side in a display region; and
an image display configured to display an image in the display region,
when displaying the first image data and the second image data side by side in the display region, the image display displays, in the display region, an image of third image data generated based on the first image data and the second image data and transferred from the image processing device, and
when displaying the first image data and fourth image data acquired from the first information processing device side by side in the display region, the image display displays, in the display region, an image of fifth image data generated based on the first image data transferred from the image processing device and the fourth image data transferred from the first information processing device.

2. The display system according to claim 1, wherein
the image processing device stores first predetermined image data, and
when the image display displays the first image data and the second image data side by side in the display region and the first acquirer did not detect a signal concerning the first application program,
the image processing device generates the third image data based on the first predetermined image data and the second image data, and
the image display displays, in the display region, an image of sixth image data generated based on the third image data and OSD data indicating that the signal concerning the first application program is undetected.

3. The display system according to claim 1, wherein
at least one of the image processing device and the display device stores second predetermined image data, and
when the image display displays the first image data and the fourth image data side by side in the display region and the first acquirer did not detect a signal concerning the first application program,
the image display displays, in the display region, an image of seventh image data generated based on the second predetermined image data, OSD data indicating that the signal concerning the first application program is undetected, and the fourth image data.

4. The display system according to claim 1, wherein the first communicator includes:
an image transferer configured to transfer image data between the image processing device and the display device; and
a signal communicator configured to communicate a signal between the image processing device and the display device.

5. The display system according to claim 1, wherein
the image processing device stores the first application program, and
the image processing device starts the first application program in a period in which an image of the first image data is displayed in the display region.

6. The display system according to claim 2, further comprising a second information processing device, wherein
the second information processing device stores the first application program and is connected to the image processing device via the first acquirer,
the signal concerning the first application program is a signal of the first image data transferred from the second information processing device, and
the OSD data indicating that the signal concerning the first application program is undetected is information indicating that image data is unacquired.
